(19) United States
(12) Patent Application Publication
(10) Pub. No.: US 2015/0046351 A1
(43) Pub. Date: Feb. 12, 2015

(54) IMPLIED LINK-BASED MISUSE DETECTION

(71) Applicant: Verizon Patent and Licensing Inc., Arlington, VA (US)

(72) Inventor: Mohammad Reza Tayebnejad, Colorado Springs, CO (US)

(73) Assignee: Verizon Patent and Licensing Inc., Arlington, VA (US)

(21) Appl. No.: 13/960,133

(22) Filed: Aug. 6, 2013

(51) Int. Cl. G06Q 30/00

(52) U.S. Cl. CPC G06Q 30/0185
USPC 705/318

(57) ABSTRACT

An exemplary system that includes a computing device receiving data that identifies a set of providers including a target provider. The computing device performs a link-based attribute pre-process on the data to identify, based on the set of providers, a node network structured around the target provider and to generate a set of link-based attributes for the target provider. The computing device classifies the target provider based on the set of link-based attributes.

### BACKGROUND

An economic system is an environment for providing goods and services by suppliers, agencies, and entities (e.g., providers) to be consumed by a combination of various users, purchasers, and recipients. The structure of a given economic system derives from how the providers are linked to one another, as documented by the information and compensation passing through those links.

For example, the healthcare industry may be referred to as an economic system. The structure of the healthcare industry may derive from links or relationships between the interdisciplinary teams of medical service providers (e.g., trained medical practitioners, specialists, professionals, and paraprofessionals) that meet the health needs of individuals by providing diverse goods and services to treat patients. Further, the healthcare industry may track the goods and services by collecting and recording instances of patient treatments, such as when medical service providers record patient treatment instances as service records and/or when healthcare insurance providers receive insurance claims relating to the instances.

Unfortunately, providers may misuse an economic system by exploiting the links and compensations associated with those links through collaboration. Misuse may further include abuse, such as large scale multi-link collaboration, and/or fraud, such as recording false information. Examples of abuse or fraud in the healthcare system include charging for services not rendered, charging for services rendered but not needed, upcoding, and patient fraud, such as an illegal use of an insurance ID to receive/render services.

An approach to misuse detection in an economic system may be a policy-violation based detection. In this approach, recorded information and compensation are reviewed for policy compliance and the providers are flagged as misuse if the recorded information and compensation violate a set of defined rules or regulations. Returning to the healthcare industry example, service records and insurance claims may be processed or mined to extract basic attributes (e.g., data entered into or contained within the record or claim), such as a rendering medical service provider, a referring medical service provider, and a treatment rendered by the rendering provider. If the basic attributes of the service record or insurance claim violate a particular rule or regulation, then the medical providers associated with that service record or insurance claim may be flagged for possible misuse.

The policy-violation approach has serious shortcomings. For example, the policy-violation approach has a very limited detection scope that flags only very specific types of misuse, as the basic attributes by their nature are limiting. Further, the policy-violation approach is not able to detect large scale multi-link collaboration that is carried out systematically over an extended period of time to avoid violating the defined rules and regulations. Nor is the policy-violation approach able to detect fraud, such as the recording of false information to purposefully observe the set of defined rules and regulations while exploiting links and compensations.

What is needed is a detection mechanism that goes beyond a policy-violation approach to intelligently identify misuse, abuse, and/or fraud within an economic system.

### BRIEF DESCRIPTION OF THE DRAWINGS

FIG. 1 illustrates a healthcare system as an exemplary economic system;

FIG. 2 illustrates an exemplary process flow of a detection mechanism that detects misuse of the healthcare system;

FIG. 3 illustrates an exemplary computing system including a processing unit and a memory with a detection application installed thereon that detects misuse;

FIG. 4 illustrates an exemplary schematic of propagation mapping by a detection mechanism;

FIG. 5 illustrates an exemplary process flow of one implementation of a detection mechanism that detects misuse of an economic system; and

FIG. 6 illustrates an exemplary process flow of another implementation of a detection mechanism that detects misuse of an economic system.

### DETAILED DESCRIPTION

A detection mechanism, disclosed herein, goes beyond the policy-violation approach by making characterizations from the links of an economic system and the information passing through those links in support of generating a probability of economic system misuse, abuse, and/or fraud.

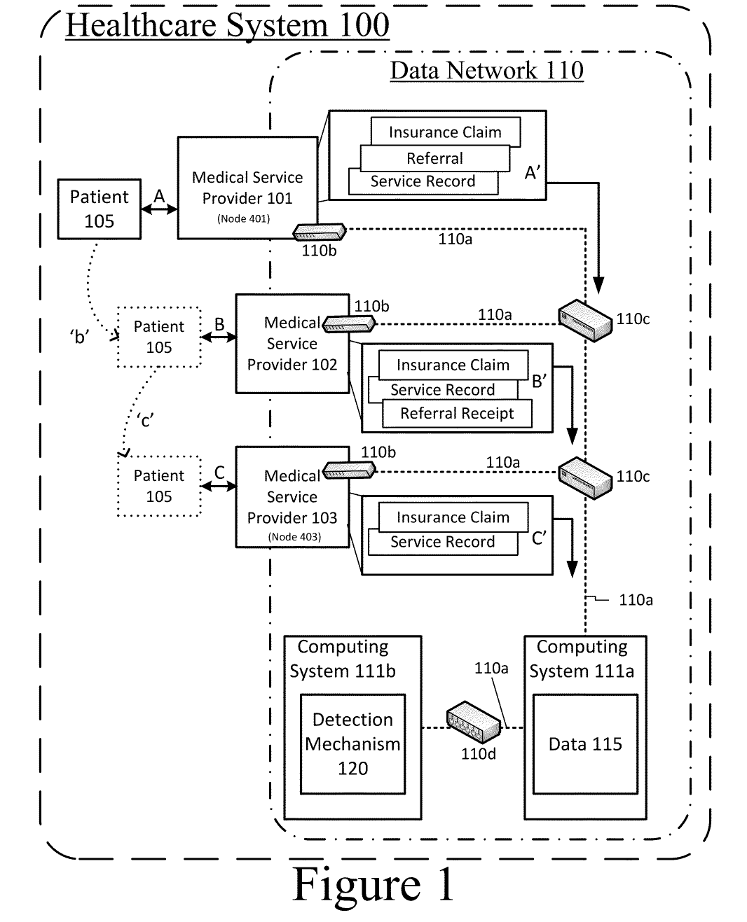

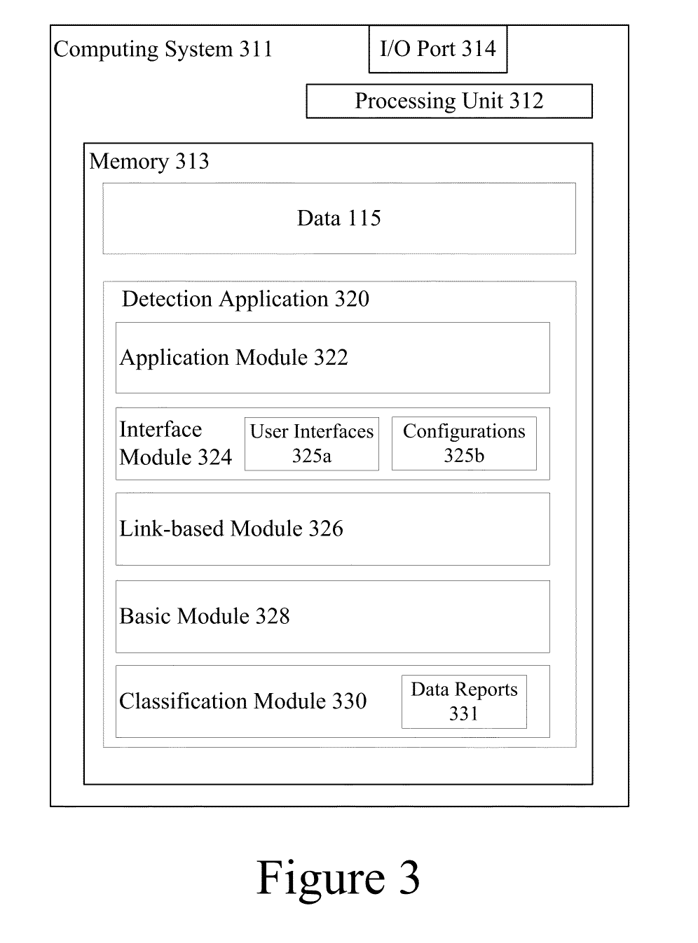

For ease of understanding, FIG. 1 illustrates a healthcare insurance system (“healthcare system 100”), which may be considered a sub-part of the healthcare industry described above, as an example of an exemplary economic system. The healthcare system 100 includes medical service providers 101, 102, 103 that respectively provide goods and services A, B, C to a patient 105 and generate system information A′, B′, C′ (e.g., at least one of service record, referral, and insurance claim), which is collected and stored via a data network 110 as data 115 within computing system 111a. A healthcare insurance provider for a patient 105 may generally access and process the data 115 to compensate the medical service providers 101, 102, 103 for providing the respective goods and services A, B, C to a patient 105. Further, because medical service providers 101, 102, 103 may misuse the healthcare system 100 by exploiting the compensation services of the healthcare insurance provider, the healthcare insurance provider may utilize a detection mechanism 120 within a computing system 111b to identify misuse of the healthcare system 100 from the data 115, which is communicated to and from the detection mechanism 120 via the data network 110. Computing systems 111a, 111b will be further described below with reference to FIG. 3 and computing system 311.

The healthcare system 100 is an environment utilized by the healthcare insurance provider for tracking and compensating the medical goods and services A, B, C of the medical service providers 101, 102, 103 received by a patient 105 who has an insurance policy with the healthcare insurance provider. The medical service providers 101,102, 103, as indicated above, may be the trained medical practitioners, specialists, professionals, and paraprofessionals that meet the health needs of individuals by providing diverse goods and services A, B, C to treat patients. Medical goods and services A, B, C in general may be any examination, diagnosis, treatment, prescription, referral, or combination thereof or of for a patient 105 by medical service providers 101, 102, 103.

In FIG. 1, the first medical service provider 101 may be a primary care physician who provides first contact medical services A for a patient 105 with an undiagnosed health concern as well as continuing care of varied medical conditions. The second medical service provider 102 may be any medical specialist who provides second contact medical services B for a patient 105 with a diagnosed health concern as well as related specialized continuing care. The third medical service provider 103 may be any medical professional who provides the examination services C for a patient 105 in support of diagnosing or treating a medical concern.

Thus, as an example, a patient 105 who is experiencing knee pain may first visit the primary care physician who administers the first contact medical services A that diagnoses the knee pain as a damaged ligament. The patient 105 may then visit ‘b,’ a specialist who administers the second contact medical services B that further diagnose the knee pain as a damaged anterior cruciate ligament. The patient 105 may next visit ‘c,’ a specialist who provides examination services C via a magnetic resonance imaging scanner to image the degree of damage for the anterior cruciate ligament.

The structure of the healthcare system 100 derives from how the system information A′, B′, C′ details the links between the medical service providers 101, 102, 103. For example, healthcare insurance providers require evidence (e.g., system information A′, B′, C′) of a medical service rendered to a policy holder (e.g., patient 105) to pay a medical service provider. System information A′, B′, C′ in general detail insurance and patient information, such as service recipients, policy holders, rendering providers, referring providers, service costs, diagnosis, service types, claim types, and the like, and insurance and patient information may be presented in the forms of a service record and/or insurance claim as illustrated.

Thus, as an example, the details relating to the first contact medical services A, the second contact medical services B, and the examination services C may be respectively recorded as system information A′, B′, C′ and collected as data 115, such that the health insurance provider may compensate each provider 101, 102, 103 for treating the patient 105. Further, healthcare insurance providers, such as health maintenance organizations (i.e., HMOs) and/or other managed care schemes, may also require a referral for a patient 105 to see any specialist or professional other than a patient's primary care physician.

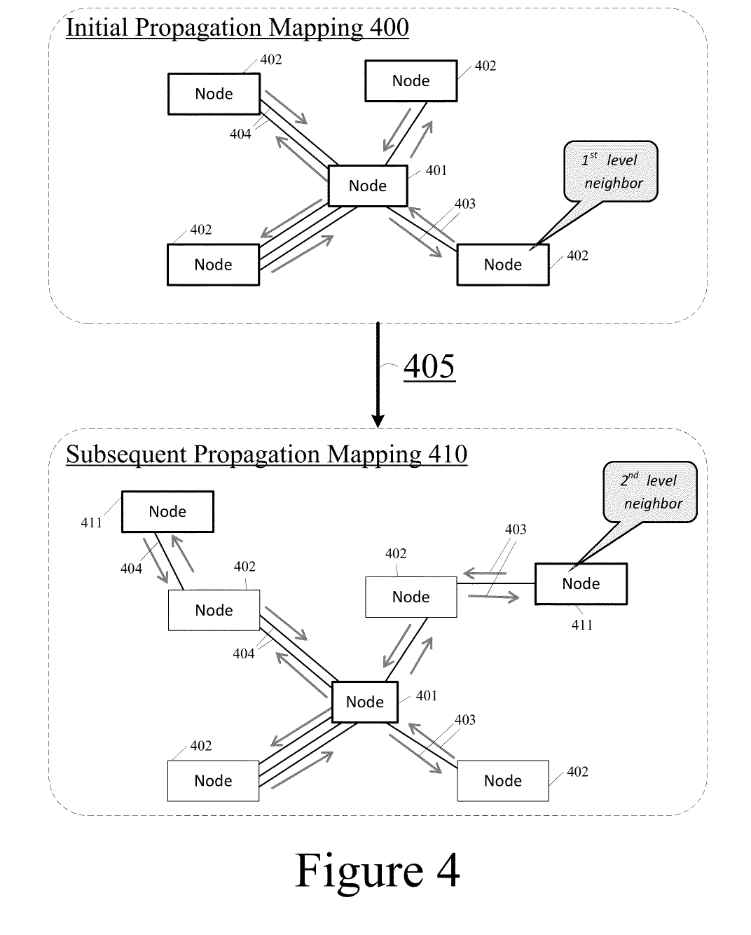

The term “referral” may include the act of the first medical service provider 101 sending a patient 105 to the second or third medical service provider 102, 103, and/or the actual paper authorizing a patient visit. A referral between medical service providers may sometimes be accompanied by a monetary remuneration. A monetary remuneration may be a percentage of income given to a referring provider from the rendering provider as payment for having made the original income for the rendering provider possible. A monetary remuneration may incentivize improper collaborative referrals between medical service providers enabling misuse of the healthcare system 100, and may sometimes be referred to as a referral reward or payment. In the example of FIG. 1, the medical service provider 101 referred the patient 105 to the subsequent providers 102, 103 and thus, recorded the referral as part of the system information A′. Based on the referral, the medical service providers 102, 103 may become peer providers to medical service provider 101. Therefore, when the detection mechanism 120 generates a node network, as further described below, medical service provider 101 may be identified as a target node with the medical service providers 102, 103 linked as two neighboring nodes. A further description of node networks is provided below with respect to the discussion associated with FIG. 4.

A data network 110 may be an infrastructure that generally includes edge 110b, distribution 110c, and core devices 110d and provides at least one path for the exchange of information between different devices and systems (e.g., between the computer systems of the medical providers 101, 102, 103 and computing systems 111a, 111b). Data network 110 may be a plurality of individual networks interconnected with one another. Further, the data network 110 may be any conventional networking technology, and may, in general, be any packet network (e.g., any of a cellular network, global area network, wireless local area networks, wide area networks, local area networks, or combinations thereof, but may not be limited thereto) that provides the protocol infrastructure to carry communications between multiple computing systems, databases, and at-home systems. The data network 110 may include wired or wireless connections 110a between two endpoints (e.g., devices and/or systems as further described below) that carry electrical signals and that facilitate virtual connections (protocol infrastructure) that enable communication to and from the multiple computing systems, databases, and systems on the data network 110.

Data 115 may include any type of data or file system (e.g., service records and insurance claims) that operates to support the detection mechanism 120. For instance in the healthcare system 100, the data 115 may be a collection of records (e.g., system information A′, B′, C′), each record including any combination of information or basic attributes regarding service recipients, policy holders, rendering providers, referring providers, service costs, diagnosis, beneficiaries, location of treatments, service types, claim types, etc. In one illustrative approach, the following exemplary basic attributes extracted from the data 115 may be utilized as an input for the detection mechanism 120: information on service recipient or policy holder; information on rendering provider; information on referring provider; and information on service and claim.

In general, databases, data repositories or other data stores, such as data 115, described herein may include various kinds of mechanisms for storing, providing, accessing, and retrieving various kinds of data, including a hierarchical database, a set of files in a file system, an application database in a proprietary format, a relational database management system (RDBMS), etc. Each such data store may generally be included within a computing system (e.g., computing system 311 described below) employing a computer operating system such as one of those mentioned above, and are accessed via a network or connection in any one or more of a variety of manners. A file system (e.g., the service records and insurance claims) may be accessible from a computer operating system, and may include files stored in various formats. An RDBMS generally employs the Structured Query Language (SQL) in addition to a language for creating, storing, editing, and executing stored procedures. Thus, although the data 115 is illustrated as a block within the data network 110, it is understood that the data may be stored locally or remotely on a memory of a singular computing system or stored locally, remotely, and/or distributed across multiple systems, while being accessible or retrievable through the data network 110 by the detection mechanism 120.

The detection mechanism 120 may be configured to analyze and pre-process the data 115 communicated via the data network 110 for link-based and basic attributes. In general, linked-based attributes are the characteristics of a particular provider as described from a related provider. For instance, if the medical service provider 101 is the particular provider being evaluated, then the basic attributes within the system information B′, C′ of medical service providers 102, 103 would be utilized to generate characteristics for medical service provider 101. Therefore, linked-based attributes may be the aggregated effect of characteristics or properties of a related provider on a target node (See also, the discussion related to Equation 1 and 2 below). The detection mechanism 120 may then utilize the link-based and basic attributes (e.g., a feature vector) in a classification heuristic to generate a probability of economic system misuse, abuse, and/or fraud within the healthcare system 100. A feature vector is a numerical representation of a complete set of attributes, e.g., linked-based and basic attributes individually or in combination, passed through a processing and statistical analysis for scoring or classification.

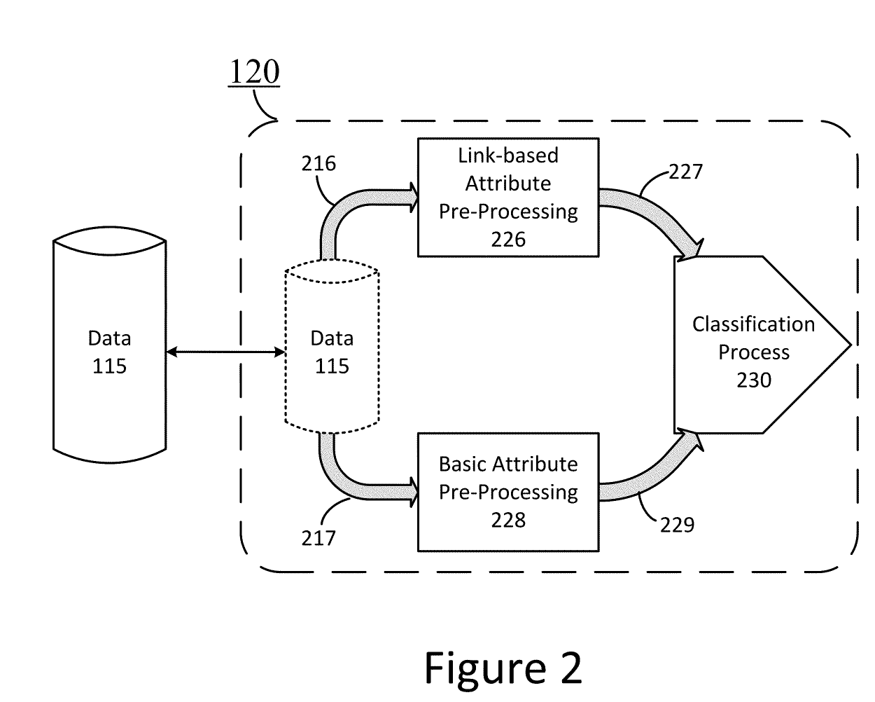

FIG. 2 illustrates an exemplary process flow of a detection mechanism 120 that generates a probability of a healthcare system misuse. In the exemplary process flow, once the data 115 is communicated to the detection mechanism 120, the data may be utilized as an input 216, 217 for a link-based attribute pre-processing 226 and a basic attribute pre-processing 228. The outputs 227, 229 of the pre-processing are received for use by the classification process 230, which generates a probability of system abuse and fraud. The output 227, 229, in general, may in combination be a feature vector.

As shown in FIG. 2, the data 115 may be received and utilized by the detection mechanism 120 as an input 216 for link-based attribute pre-processing 226. The link-based attribute pre-processing 226 may produce characterizations (e.g., link-based attributes) about providers 101, 102, 103 in the healthcare system 100 based on the basic attributes contained within the system information A′, B′, C′. To make characterizations, the link-based attribute pre-processing 226 of the detection mechanism 120 may build a relational node network from the data 115, where each node represents a provider (including a node 401, 402, 403 for each medical service provider 101, 102, 103 as further described in reference to FIG. 4). For example, the link-based attribute pre-processing 226 may logically build from the data 115 a distinct relational node network for each medical service provider 101, 102, 103, each relational node network being centered on the relative provider. Thus, if three providers are present in the data, then three distinct relational node networks are generated, with each distinct relational node network being the particular universe for a provider (e.g., the provider is at the center or is the target).

Through each distinct relational node network, the link-based attribute pre-processing 226 accumulates basic attributes (e.g., parameters, as described below) for each target node from neighboring nodes to generate a set of link-based attributes specific to each node. The link-based attribute pre-processing 226 supplies the set of link-based attributes as an output 227 for further use during the classification process 230.

The data 115 may also be received as an input 217 for basic attribute pre-processing 228, and may be received individually or in batches. Basic attribute pre-processing 228 may include extracting basic attributes performing various transformations such as scaling and normalization for each provider based on the parameters of each node. The basic attribute pre-processing 228 supplies the basic attributes as an output 229 for further use during classification process 230.

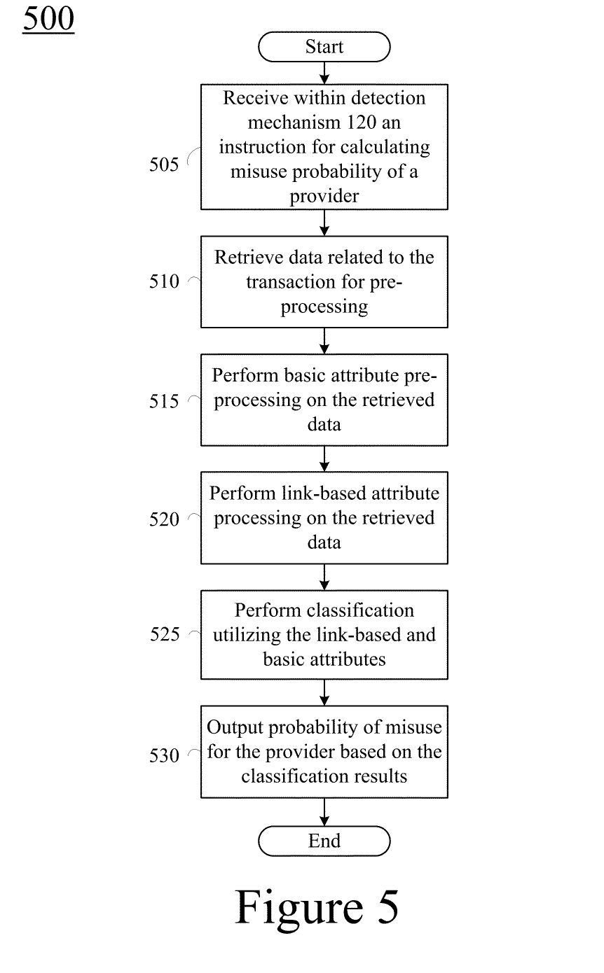

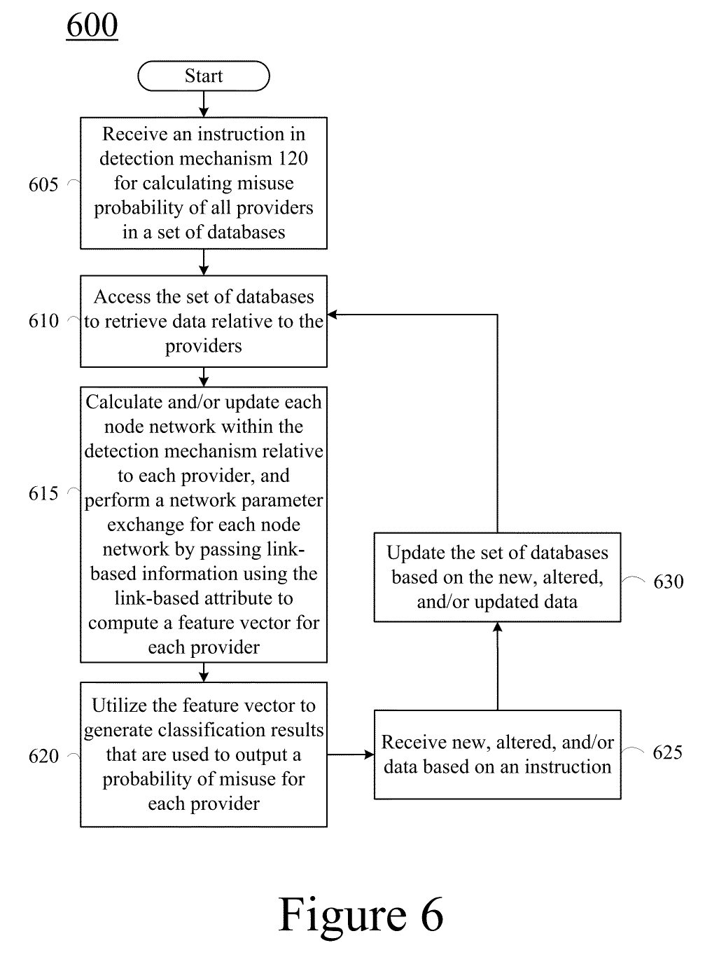

The data 115 may be pre-processed 226, 228 by the detection mechanism 120 simultaneously as shown in FIG. 2 or sequentially, where the data 115 is pre-processed for a first attribute type (e.g., basic or link-based) and then pre-processed for the remaining attribute type. For example, FIG. 5 illustrates a sequential pre-processing (515, 520) by the detection mechanism 120. Further, FIG. 6 also illustrates a simultaneously pre-processing (615), and may be referred to as batch processing. Batch processing is an automatic execution of a series of scripts (e.g., predefined command code) that take a set of data as input, processes the data according to the predefined command code, and produces a set of output data files and is termed as “batch processing” because the input data 115 are collected into batches of files and are processed in batches by the detection mechanism 120. In one approach the batch processing may include updating the entire database at one time. The updating may take at predefined times. The data 115 may also be pre-processed 226 for link-based attributes by the detection mechanism 120 without pre-processing 228 for basic attributes.

Classification process 230 may be a utilization of a feature vector (the outputs 227, 229) by a classification heuristic that in turn outputs misuse statistics or probabilities (e.g., class labels or scores) for each node (e.g., provider). Examples of class labels may include ‘no fraud,’ ‘possible fraud,’ ‘colaborator,’ ‘fraud actor,’ and/or ‘service providers fraud: charging for services not rendered.’ Examples of class scores may include a fraud probability, such as a value on a range from 0 to 1 that represents a probability percentage, where 0 represents a lowest probability and a 1 represents a highest probability of fraud. The classification heuristic may map a class label or score for each node based on the set of link-based attributes specific to each node and received as an output 227. For instance, the classification process 230 may render a class label or score for the provider represented by or related to each specific node. In addition, the classification process 230 may complement the set of link-based attributes with the set of basic attributes specific to each node and received as an output 229 to enhance the rendering of class labels and scores for the provider represented by or related to each specific node. Therefore, the classification process 230 may be a processing of the combination of link-based attributes and basic attributes (e.g., the feature vector) to label or score the data 115.

Thus, detection mechanism 120 may utilize the data 115, which includes system information A′, B′, C′ that details service record, referral, and insurance patient information (e.g., such as service recipients, policy holders, rendering providers, referring providers, service types, claim types, and the like) to classify the medical service providers 101, 102, 103. For example, the detection mechanism 120 may perform a link-based attribute pre-processing 226 to build a relational node network by utilizing the system information A′, B′, C′, where each node represents a medical service providers. Through the relational node network, the link-based attribute pre-processing 226 accumulates parameters at each node from neighboring nodes to generate the set of link-based attributes specific to each node. The detection mechanism 120 may utilize the classification heuristic to map a misuse probability for each node based on the set of link-based attributes specific to each node and render a class label or score (e.g., misuse statistics) for the provider represented by or related to each specific node. In turn, the detection mechanism 120 may intelligently identify misuse, abuse, and/or fraud (e.g., associate providers with labels or scores) regarding improper referrals and monetary remunerations between medical service providers 101, 102, 103 within the healthcare system 100.

The detection mechanism 120 will now be described below in connection with FIG. 3. FIG. 3 illustrates an exemplary computing system 311 including a processing unit 312 and a memory 313 with a detection application 320 installed thereon that provides the operations of the detection mechanism 120 described herein. The detection application 320 may comprise an application module 322, an interface module 324 (which generates user interfaces 325a and manages configurations 325b), a link-based module 326, a basic module 328, and a classification module 330 along with a data 115 (which manages the service records and insurance claims). The computing system 311 may also include an input/output (I/O) port 314.

Computing system 311 may take many different forms and include multiple and/or alternate components and facilities. While an exemplary system 311 is shown in FIG. 3, the exemplary components illustrated in FIG. 3 are not intended to be limiting. Indeed, additional or alternative components and/or implementations may be used.

In general, the computing system 311 utilizes the detection application 320 to process the data 115 and generate a misuse probability for the processed data in support of detecting abuse of and fraud within an economic system. For instance, the application module 322 of the detection application 320 retrieves and forwards the data 115 to the link-based module 326 and the basic module 328. The link-based module 326 performs the link-based attribute pre-processing on the received data 115, which in turn generates an output 227. The basic module 328 may perform the basic attribute pre-processing on the received data 115, which in turn generates an output 229. The classification module 330 utilizes at least the output 227 to generate class label or score for the data 115. The classification module 330 may also utilize both outputs 227, 229 to classify the data 115.

Computing systems and/or devices, such as computing systems 111a, 111b, 311, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing systems and/or devices include, without limitation, a computer workstation, a server, a desktop, notebook, laptop, or handheld computer, or some other computing system and/or device.

Computing systems and/or devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc.

In addition, computing systems and/or devices may include a power supply. A power supply may be any power source, such an internal power device consisting of one or more electrochemical cells that convert stored chemical energy into electrical energy and is configured to supply electricity to the components of the computing systems and/or devices. The power supply may also be a power cord to an external power source in combination with or lieu of the internal power device.

Further, in some examples, elements of the computing system 311 may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In general, a processor or a microprocessor (e.g., processing unit 312) receives instructions from a memory (e.g., memory 313) and executes these instructions, thereby performing one or more processes, including one or more of the processes described herein. Such instructions and other data may be stored and transmitted using a variety of computer-readable media. The processing unit 312 may also include processes comprised from any hardware, software, or combination of hardware or software that carries out instructions of computer programs by performing logical and arithmetical calculations, such as adding or subtracting two or more numbers, comparing numbers, or jumping to a different part of the instructions. Examples of the processing unit 312 may be any one of, but not limited to single, dual, triple, or quad core processors (on one single chip), graphics processing units, visual processing units, and virtual processors.

The memory 313, in general, may be any computer-readable medium (also referred to as a processor-readable medium) that may include any non-transitory (e.g., tangible) medium that participates in providing data (e.g., instructions) that may be read by a computing system (e.g., by a processing unit 312 of a computing system 311). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computing system. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The input/output (I/O) port 314 may include and is representative of any connector or set of connectors used for digital or analog signal transfers. For instance, the I/O port 314 may be any physical port implementing a wired exchange of data and/or any antenna technology that implements a wireless exchange of data, such as cellular, Bluetooth®, or the like, by converting propagating electromagnetic waves to and from conducted electrical signals (e.g., the I/O port 314 may implement Wi-Fi to exchange data wirelessly using radio waves over a short range network). Further, the I/O port 314 may connect and communicate across a network (e.g., data network 110), which may be a collection of computers and other hardware that provides infrastructure to carry communications. In one illustrative approach, an application module 322 (described below) may include program code for communication with a data systems external to computing system 311 (e.g., the application module 322 may retrieve the data 115, individually or in batches, through the I/O port 314 and supply it to the other modules for processing).

In FIG. 3, the memory 313 of computing system 311 includes data 115 and the detection application 320, where the detection application 320 is configured to pre-process and classify data 115 in support of detecting misuse of the economic system.

A detection application 320 and its components (322, 324, 326, 328, 330) may be software stored in the memory 313 of the computing system 311 that, when executed by the processing unit 312 of the computing system 311, provide the operations of the detection mechanism 120 described herein. Alternatively the detection application 320 and its components may be provided as hardware or firmware, or combinations of software, hardware and/or firmware. Additionally, although one example of the modularization of the detection application 320 is illustrated and described, it should be understood that the operations thereof may be provided by fewer, greater, or differently named modules.

The detection application 320 may store, manage, and execute pre-processing and classification heuristics. Pre-processing and classification heuristics are a suite of models and methodologies that in combination output a probability of economic misuse for a particular provider. Link-based attributes look at an individual and its neighbors to infer a type of characteristic or behavior. This is in contrast to a policy-based approach, which is generally oblivious to how providers are linked and instead looks at the application of rules and regulations.

The detection application 320 may employ the application module 322 to receive a record or batch of records from the data 115 for pre-processing by the heuristics of the link-based module 326 and basic module 328. The results of pre-processing, e.g., the feature vector, are then inputted into the classification heuristic of the classification module 330, which outputs misuse statistics for providers associated with the record (the pre-processing and classification heuristics are further described below in relation to their respective modules). The misuse statistics along with the record and provider may then be packaged by the interface module 324 in a user interface 325a for presentation to a user.

An application module 322 may include program code configured to facilitate communication between the modules of the detection application 320 and hardware/software components external to the detection application 320. For instance, the application module 322 may include program code configured to communicate directly with other applications, modules, models, devices, and other sources through both physical and virtual interfaces. That is, the application module 322 may include program code and specifications for routines, data structures, object classes, and variables that package and present data received from user interfaces 325a generated by the interface module 324 for transfer through the I/O port 314 over a network.

An interface module 324 may include program code for generating and managing user interfaces 325a that control and manipulate the detection application 320 based on a received input. The interface module 324 also may include program code for generating and managing configurations 325b that control and manipulate the detection application 320 based on scripts (e.g., predefined command code) that take a set of data as input, processes the data according to the predefined command code, and produces a set of output data files. User interfaces 325a may enable the direct selection and manipulation of configurations 325b, pre-processing and classification heuristics, and data 115. For instance, the interface module 324 may include program code for generating, presenting, and providing one or more user interfaces 325a (e.g., in a menu, icon, tabular, map, or grid format) in connection with other modules for providing information (e.g., data, notifications, counters, instructions, etc.) and receiving inputs (e.g., instructions regarding data 115 analysis, propagation levels, etc.).

Moreover, user interfaces 325a described herein may be provided as software that when executed by the processing unit 312 provides the operations described herein, such as displaying a probabilities estimating misuse of the healthcare system. The user interfaces 325a may also be provided as hardware or firmware, or combinations of software, hardware, and/or firmware.

The link-based module 326 may include program code configured to store, manage, and execute link-based pre-processing heuristics that preform link-based attribute pre-processing 228 of data 115 (e.g., an analysis that involves a network parameter exchange, as described below). The link-based module 326 may further generate link-based attributes from the data 115 into an output 229 for further use during classification (230) by the classification module 330. The link-based module 326 may stand alone or be complemented by the basic attribute pre-processing 226 of the basic module 328. That is, the link-based module 326 and the basic module 328 may perform the complementary pre-processing simultaneously, as in FIGS. 2 and 6, or sequentially, as in FIG. 5.

The link-based pre-processing heuristics of the link-based module 326 may perform a network parameter exchange. A network parameter exchange builds a relational node network from the data 115 and exchanges parameters (e.g., basic attributes) between the nodes. In particular, the link-based pre-processing heuristics maps providers, based on service records and insurance claims (e.g., system information), as nodes in a relational node network (e.g., propagation mapping) by utilizing the basic attributes or ‘parameters’ within the system information. The parameters of each node are then passed through ‘links’ between the nodes, such that each node accumulates parameters from neighboring nodes in addition to that node's local parameters. Once the parameters are exchanged, a particular node is selected based on the provider or record under investigation and the parameters passed to the selected node are aggregated and weighted to generate link-based attributes for the selected node. The link-based attributes along with the basic attributes are used by classification module 330 to perform classification or scoring. Therefore, network parameter exchange of the link-based pre-processing heuristics assists in identifying the behavior of actors, based on the link-based attributes, in the context of the relational node network, which in turn enables economic system misuse detection. For example, the link-based module 326 may perform a link-based attribute pre-processing 226 by implementing the network parameter exchange to logically build from the data 115 a distinct relational node network for each medical service provider 101, 102, 103, each relational node network centered on the relative provider (e.g., the provider is at the center or is the target node as described below).

Parameters of a node are the basic attributes (e.g., data entered into or contained) within the system information for that node and relating to neighboring nodes (e.g., peer providers). Examples of parameters within the system information for a node may include a number of unique neighboring nodes, a number of unique service goods or recipients, a number of recipients whose ID is potentially compromised, a total number of claims (e.g., medical claims) tendered by the provider associated with the node, and a total cost of claims (e.g., medical claims) tendered by the provider associated with the node.

Examples of parameters within the system information for a node may also include the number of neighboring nodes already suspect or under investigation, a number of neighboring nodes with known goods or service recipient complaints, a total number of claims (e.g., medical claims) tendered by providers associated with neighboring nodes that are under investigation, a total cost of claims (e.g., medical claims) tendered by providers associated with neighboring nodes that are suspect or under investigation, a number of claims (e.g., medical claims) by providers associated with neighboring nodes that have beneficiary complaints, and a cost of claims (e.g., medical claims) by providers associated with neighboring nodes that have beneficiary complaints.

Further, examples of parameters within the system information for the node may include an average geographic distance from the provider mapped to the node to other providers associated with neighboring nodes, an average geographic distance to beneficiaries from the provider mapped to the node, a distance count (e.g., the geographic distance between the address or location of two providers) between providers associated with neighboring nodes exceeding a threshold, a distance count between beneficiaries exceeding a threshold, a count of beneficiaries with an expense greater than a threshold amount, a number of services within a unit time greater than a threshold, and a total service cost in a unit time greater than some threshold. A threshold may be a predetermined configurable value governed by configurations 325b and utilized by the heuristics to describe the node. A threshold for any parameter may be previously established and/or configured through a user interface 325a of the detection application 320.

For example, when a neighboring node is directly connected to a target node, that neighboring node may be considered a first level neighboring node. The level of a node may be defined by a hop count that indicates the number of nodes between the target node and the specific neighboring node, such that first level nodes have a hop count of 0. When a subsequent neighboring node is connected to a target node through a first level neighboring node, that subsequent neighboring node may be considered a second level neighboring node with a hop count of 1 due to the first level neighbor being an intermediary node. Thus, the detection application 320 may utilize a threshold of 1 to include, exclude, or identify the parameters of neighboring nodes with a hop count of 1 or greater.

The above examples of parameters are not an exclusive list and may be expanded, revised or contracted to include any type of information that may be useful in characterizing network nodes, such as information that highlights the anomalous characteristics of the actors or providers listed on the service records or insurance claims (e.g., system information), which may be more relevant in misuse detection. The economic system may also influence the makeup of other examples of parameters. For instance, in an international shipping economic system, packaging slips for cargo may be the system information that contains the basic attributes for mapping shipping providers within a node network. Further, the parameter of ‘a total number of claims (e.g., medical claims) tendered by the provider associated with the node’ may be altered to ‘a total number of packages shipped by the provider associated with the node.’

Links between the nodes are connecting edges in the relational node network environment in which basic attributes and information propagate across and are the underlying mechanisms to spread similar characteristics in the relation node network while reinforcing similar behavior in a node neighborhood. An example of a link between two nodes is when two service providers appear on the same claim (e.g., service record) as a referring provider and as a rendering provider 102. In relational node network terminology, these two nodes are linked directly and they are referred as first level neighboring nodes. This definition of link relies on a working relation between two nodes, but there are other ways to link network nodes, for example through common patients, service location, etc. The strength of a link between two nodes is determined, for example, by the frequency of the transactions and exclusivity of the relationships between two nodes.

The network parameter exchange of the link-based pre-processing heuristics will now be described in reference to FIG. 4, which illustrates an exemplary schematic of propagation mapping and a resulting relational node network. In FIG. 4, an initial propagation mapping 400 resulting from a first iteration of the link-based pre-processing heuristics is shown along with a transition 405 to a subsequent propagation mapping 410 based on a second iteration of the link-based pre-processing heuristics.

In the first iteration, a relational node network is built by the link-based attribute pre-processing 226 of the detection mechanism 120 from the data 115 and information about direct or immediate neighbors is exchanged the link-based attribute pre-processing 226 between nodes. The initial propagation mapping 400 is an example of this relational node network where the link-based pre-processing heuristics discover a node 401, locate the neighboring nodes 402 based on the parameters of node 401, establish the links 404 between the neighboring nodes 402 and the node 401 based on the parameters of node 401, and exchange 403 the parameters of each connected node across the links 404.

Node 401, which in this case is the target node or service provider under investigation, is next described by the gathered parameters of each connected node, according to equation 1:

$$S ( j ) = {\sum }_{k = 1}^{Neigh ( j )} ( \frac{Parameters\_Node ( k ) * Weight ( k , j )}{Total\_Links \_Node ( k )} ) \qquad Equation 1$$

where, S(j) is an aggregated effect on node j (e.g., node 401) by the neighboring nodes Neigh(j) (e.g., neighboring nodes 402 or each node k); Parameters_Node(k) is parameters of node k; Weight(k,j) is the weight or strength of relation between node k and node j; and Total_Links_Node(k) is the total number of links for node k to all the other nodes that are connected to node k. That is, for each neighboring node Neigh(j), the parameters that relate to node k (Parameters_Node(k)) on that particular neighboring node Neigh(j) are multiplied by a strength (Weight(k,j)) and that product is divided by the total number of links for node k to all the other nodes (Total_Links_Node(k)). Note that Total_Links_Node(k) is inversely related to the “exclusivity” of relation between nodes j and k. That is, the smaller the number of links for node k (the smaller the denominator for that neighboring node 402) the more exclusive the relation between node k and node j.

In the relational node network, any node may be selected as a target node (e.g., service record under investigation) and any node connected to the target node is a neighboring node (e.g., service records related to the target node). Neighboring nodes may be classified as first level neighboring nodes when they directly connect to the target node or higher order neighboring nodes, whose higher order depends on the number of intervening nodes between itself and the target node (e.g., a third level neighboring node includes two intervening nodes on the path between itself and the target node). Thus, the network parameter exchange of the link-based pre-processing heuristics aggregates the parameters of a target node through data characterization sequences that utilize information (e.g., parameters) from neighboring nodes. That is, information is passed from the neighboring nodes through links to the target node, where the information is aggregated and processed to characterize the target node. The aggregation process may weigh the contribution of each node, k, proportional to the number of connections it has to the target node and inversely proportional to the total number of links for node k. In an alternative exemplary approach a weight given to the information within a neighbor may be proportional to the level at which a node related to the target node, and that weight decreases as the number of intervening nodes increases (e.g., a parameter of a third level neighboring node may be given less weight than a parameter of a first level neighboring node). In addition, a weight of the relation between nodes may be determined by the frequency of the dealings between the nodes which in turn influences the flow of information between the nodes.

After the first iteration, the link-based pre-processing may perform a designated number of subsequent iterations (each new iteration may be considered an expansion of the relational node network). During the subsequent iterations, node parameters of higher order neighbors, as well as information on direct or immediate neighbors, are exchanged. As seen in FIG. 4, the relational node network of the initial propagation mapping 400 transitions 405 to a subsequent relational node network (e.g., subsequent propagation mapping 410) based on a second iteration.

In the second iteration, the relational node network is expanded based on the data 115 and parameters of higher order neighbors, as well as information on direct or immediate neighbors, are exchanged. That is, the subsequent propagation mapping 410 is an example of this second iteration where the link-based pre-processing heuristics discover and locate higher order neighbors (e.g., second level neighboring nodes 411) based on the parameters of established nodes 401, 402, generate the links 404 between all nodes 401, 402, 411 based on the parameters all nodes (e.g., new information in the second data may increase the number of links between any two nodes), and exchange 403 the parameters of each connected node via the links 404.

Node 401, which is still the target node, is next described by the gathered parameters of all nodes in the expanded relational node network, according to equation 2:

$$T ( j ) = {\sum }_{k = 1}^{Neigh} ( \frac{S ( k ) * Weights ( k , j )}{Total\_Node \_Links ( k )} ) \qquad Equation 2$$

where T(j) is the aggregation quantity of S(k) for node j (node 401); S(k) is an aggregated attribute computed in previous iterations; Weight(k,j) is the weight or strength of relation between node k and node j; and Total_Links_Node(k) is the total number of links for node k.

Returning back to FIG. 3, the basic module 328 may include program code configured to store, manage, and execute basic pre-processing heuristics that preform basic attribute pre-processing 228 of data 115. Basic pre-processing heuristics may perform data processing or mining sequences that extract attributes or features that are basic to classification to data 115 (e.g., ascertains patterns in the data 115). The basic module 328 may further extract and transform information (e.g., basic attributes) from the data 115 into an output 229 for further use during classification (230) by the classification module 330.

Data processing or mining sequences may include receiving a target data set (e.g., collection of records), initial analyzing and cleaning of the target set to remove noise and missing data (e.g., correcting misspellings due to data entry, reinserting a data entry found to be in the wrong field, auto-filling a billing address with a listed mailing address, etc.), and identifying the patterns sought to be uncovered within the data set (e.g., identifying that a particular insurance claim is accompanied by a referral). Data processing or mining sequences may further include an anomaly detection heuristic that identifies unusual data records (e.g., a record that lists a maternity treatment for a male patient) that require further investigation, an association rule learning heuristic that searches for relationships between variables (e.g., a age variable and vaccine variable, where a vaccine is commonly administered at a particular age), cluster detection heuristic that identifies groups and structures in the data that are similar (e.g., similar treatment types and associated costs, where a cost range may be identified from the similar treatments), and a sequential pattern heuristic that finds sets of data items that occur together frequently in sequence (e.g., a sequence of a service record, a referral, a subsequent service record, a subsequent referral, etc.).

The classification module 330 may include program code configured to store, manage, and execute classification heuristics that model and summarize the data 115 to produce misuse probability. For instance, the classification module 330 may also include program code configured to utilize the classification heuristics to perform processing classification (230) of the feature vector that includes link-based and basic attributes (e.g., outputs 227, 229 of pre-processing). The classification module 330 may include program code for generating and managing data reports 331 that package and qualify the results of processing a feature vector. Further, the data reports 331 may be passed to user interfaces 324a of the interface module 324 for presentation in, e.g., a menu, icon, tabular, map, or grid format.

Thus, the data reports 331 are the outputs of the classification module 330, which may be a class label or score that identifies the probability of fraud to a node or service provider under investigation. For example, a fraud score may be a value from 0 to 1, where 1 indicates the greatest probability and 0 indicates the least probability of fraud. Further, the classification module 330 may also output a fraud trend label, when the classification heuristic detects that multiple service providers have been improperly collaborating (e.g., large scale fraud involving multiple providers working in systematic collaboration over an extended period of time).

FIG. 5 illustrates an exemplary process flow 500 of the detection application 320 (e.g., a detection mechanism 120) that performs a sequential pre-processing of system information and generates a probability of economic system misuse. For illustrative purposes and ease of understanding, the healthcare system and referrals described above are utilized to describe FIG. 5.

For example, since a referral between medical service providers may sometimes be accompanied by a monetary remuneration, which incentivizes improper collaborative referrals, the exemplary process flow 500 illustrates analyzing a provider including referral information to generate probability that the service provides identified in the referral are committing health insurance fraud to receive monetary remuneration.

The process 500 starts when instructions are received 505 into detection mechanism 120 such as through a user interface 325a of computing system 311 generated by the interface module 324 for calculating misuse probability by a provider. The instruction in this example is a request to update the fraud score for the providers involved in the transaction using the data in the new transaction.

Via the application module 322, when using computing system 311 the detection application 320 retrieves 510 the data 115 related to the provider. Note that although the data 115 is illustrated within the memory 313 of the computing system 311, the data 115 may be stored remotely and/or distributed across multiple systems (e.g., stored within the computing system 111a of FIG. 1) while being accessible or retrievable through a network (e.g., data network 110) by the detection application 320. However, for ease of explanation, the data 115 is retrieved from the local memory 313 and the applications are executed using processing unit 312.

The data 115 related to the provider includes the referral paper or claim data (e.g., the referral of service information A′) by a first medical service provider 101 (referring provider 101) authorizing a patient visit b′ to second medical service provider 102 (rendering provider 102), insurance paperwork (e.g., the insurance claim of service information A′) related to the visit to the first medical provider, and a monetary remuneration receipt (e.g., the referral receipt of service information B′) for the referral to the second medical service provider 102. The referral paper includes at least the parameter information on a service recipient and/or a policy holder, a rendering provider 102, a referring provider 101, and a referred service B.

This referral paper or claim data is next delivered as an input to the basic module 328 of the detection application 320. The basic module 328 then performs 515 a basic attribute pre-processing that extracts basic characteristics or basic attributes from the referral paper based on the parameter information. The basic attributes include the patient 105 (service recipient), the insurance policy and insurance company, a specialist (rendering provider 102), a primary care physician (referring provider 101), the type of service, the cost of the insurance claim, and the monetary remuneration to the primary care physician.

The referral paper or claim data, its information, and the basic attribute are then delivered as an input to the link-based module 326 of the detection application 320. The link-based module 326 then performs 520 a link-based attribute pre-processing that produce or update characterizations or link-based attributes for the providers listed in the referral paper or claim data. The link-based attribute pre-processing of the link-based module 326 builds via a network parameter exchange a relational node network that includes a node 401 that represents the referring provider 101 and a node 402 that represents the rendering provider 102.

Further, the link-based attribute pre-processing utilizes the relational node network to identify relationships or links between the node 401 that represents the referring provider 101 and the node 402 that represents the rendering provider 102. The link-based module 326 then exchanges the parameters of each node through links. Both the referring provider node 401 and the rendering provider node 402 accumulate the parameters during this exchange. For example, while parameters related to the referral paper, insurance paperwork, and monetary remuneration receipt (service information A′) are passed from the referring provider node 401 to the rendering provider node 402, parameters at the rendering provider node 402 are passed to and accumulated by the referring provider node 401.

Once the parameters are exchanged, a particular node is selected (in this case it is the referring provider node 401) and the parameters accumulated by the referring provider node 401 are aggregated and weighted according to Equation 1 above to generate link-based attributes for the referring provider node 401.

The classification module 330 receives the basic attributes and link-based attributes and performs 525 a classification utilizing these attributes. Particularly, the classification module 330 models and summarizes the received attributes and data 115 to produce a misuse probability for the referring provider 101. For instance, the classification module 330 utilizes the classification heuristics to perform a classification processing (230) that assigns the referring provider 101 a value from 0 to 1.

The classification module 330 then outputs 530 probability of misuse for the provider based on the assigned value, along with a class label. The detection application 320 may then through a user interface 325a display the probability of misuse for the provider, the assigned value to the referring provider, and/or the class label.

The detection application 320 may also utilize the output 530 in support of other operations. For instance, the detection application 320 may analyze at least one of the probability of misuse for the provider, the assigned value to the referring provider, and the class label. Based on when a particular probability, value, or label is detected through the analysis, the detection application 320 may trigger mechanisms for follow-up by a user, provide notifications to the proper authorities, flag a provider for system misuse, may clear a provider of suspected system misuse, and the like.

Next, the process 500 ends.

FIG. 6 illustrates an exemplary process flow 600 of the detection application 320 (e.g., a detection mechanism 120) that performs a simultaneous pre-processing of system information and generates a probability of economic system misuse. For illustrative purposes and ease of understanding, the healthcare system and referrals described above are utilized to describe FIG. 6.

The exemplary process flow 600 illustrates analyzing all providers in a set of databases. Thus, the process 600 starts when instructions are received 605 within detection mechanism 210 such as by way of a computing system 311 through a user interface 325 generated by the interface module 324 for calculating misuse probability of the providers in the batch of updated records. The instruction in this example is a configuration (e.g., 325b) submitted by the user that directs the automatic building of a relation node network based on all providers listed in a set of databases, scoring the nodes within the relation node network, automatically retrieving subsequent batches of system information, updating the databases with the subsequent batches, and rebuilding the relational node network to recalculate updated scores. Further, via the application module 322, the detection application 320 accesses 610 the setoff databases to retrieve the data relative to the providers.

With the data in hand, when using computing system 311 the detection application 320 calculates 615 and/or updates a set of relational node networks. The detection application 320 further propagates attributes via a network parameter exchange in each node network by passing link-based information using the link-based attribute to compute a feature vector for relative provider.

Particularly, the detection application 320 performs a combined link-based and basic attribute pre-processing (by utilizing Equation 1 and 2) to logically build from the data a distinct relational node network for each provider of all the providers within the data, each relational node network being centered on a particular provider (e.g., if three providers are present in the data, then three distinct relational node networks are generated, with each distinct relational node network being the particular universe for a provider.

The detection application of computing system 311 320 at 620 utilizes the feature vector to generate classification results that are used to output a probability of misuse for each provider. That is, a report (e.g., data reports 331) may be generated summarizing the probability of misuse for each provider, the report including an assigned value indicating the probability of misuse and/or a class label.

Next, the detection application 320 at 625 receives new, altered, and/or updated data based on an instruction or the configuration and updates at 630 the set of databases with the new, altered, and/or updated data. Once updated, the detection application 320 returns to calculating 615 and/or updating a set of relational node such that the economic system may be constantly monitored.

Next, the process 600 ends.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A computing device storing a detection application, the detection application being executable by a processor of the computing device to provide operations comprising:
receiving data identifying a set of providers including a target provider;
identifying, by a link-based attribute pre-process of the detection application, based on the set of providers a node network structured around the target provider,
generating, by the link-based attribute pre-process, a set of link-based attributes for the target provider; and
classifying the target provider based on the set of link-based attributes.

2. The computing device of claim 1, wherein generating each link-based attribute comprises:
accumulating, by the link-based attribute pre-process, a set of parameters at a target node from neighboring nodes of the node network, the target node corresponding to the target provider.

3. The computing device of claim 1, wherein the link-based attribute pre-process includes a first propagation iteration comprising:
identifying a set of neighboring nodes and a target node from the set of providers, the target node corresponding to the target provider; and
establishing links between each neighboring node and the target provider to structure the node network around the target provider.

4. The computing device of claim 3, wherein the link-based attribute pre-process includes basing each link-based attribute on an aggregation of parameters at the target node from an exchanging of parameters by the link-based attribute pre-process between each neighboring node and the target node via the links.

5. The computing device of claim 3, wherein the first propagation iteration further comprises:
exchanging parameters between each node of the node network based on the links to accumulate parameters on each node of the node network; and
utilizing the parameters accumulated within the target node for generating the set of link-based attributes for the target provider.

6. The computing device of claim 3, wherein the link-based attribute pre-process further comprises a second propagation iteration for expanding the node network based on the data to include a set of second tier nodes.

7. The computing device of claim 1, wherein the detection application further provides operations comprising:
performing a basic attribute pre-process on the data for generating a set of basic attributes for the target provider; and
classifying the target provider based on a combination of the set of link-based attributes and the set of basic attributes.

8. The computing device of claim 1, wherein classifying the target provider comprises:
generating, by a classification heuristic, a misuse probability based on receiving the set of link-based attributes.

9. A method, comprising:
receiving data identifying a set of providers including a target provider;
identifying, by a link-based attribute pre-process of the detection application, based on the set of providers a node network structured around the target provider,
generating, by the link-based attribute pre-process, a set of link-based attributes for the target provider; and
classifying the target provider based on the set of link-based attributes.

10. The method of claim 9, wherein generating each link-based attribute, further comprises:
accumulating, by the link-based attribute pre-process, a set of parameters at a target node from neighboring nodes of the node network, the target node corresponding to the target provider.

11. The method of claim 9, wherein the link-based attribute pre-process includes a first propagation iteration comprising:
identifying a set of neighboring nodes and a target node from the set of providers, the target node corresponding to the target provider,
establishing links between each neighboring node and the target provider to structure the node network around the target provider.

12. The method of claim 11, the link-based attribute pre-process including a second propagation iteration for expanding the node network based on the data to include a set of second tier nodes.

13. The method of claim 9, further comprising:
performing a basic attribute pre-process on the data for generating a set of basic attributes for the target provider; and
classifying the target provider based on a combination of the set of link-based attributes and the set of basic attributes.

14. The method of claim 9, wherein classifying the target provider, further comprises:
generating, by a classification heuristic, a misuse probability based on receiving the set of link-based attributes.

15. A non-transitory computer readable medium storing a detection application software program, the detection application being executable to provide operations comprising:
receiving data identifying a set of providers including a target provider;
identifying, by a link-based attribute pre-process of the detection application, based on the set of providers a node network structured around the target provider,
generating, by the link-based attribute pre-process, a set of link-based attributes for the target provider; and
classifying the target provider based on the set of link-based attributes.

16. The non-transitory computer readable medium of claim 15, wherein generating each link-based attribute, further comprises:
accumulating, by the link-based attribute pre-process, a set of parameters at a target node from neighboring nodes of the node network, the target node corresponding to the target provider.

17. The non-transitory computer readable medium of claim 15, wherein the link-based attribute pre-process includes a first propagation iteration comprising:
identifying a set of neighboring nodes and a target node from the set of providers, the target node corresponding to the target provider, and
establishing links between each neighboring node and the target provider to structure the node network around the target provider.

18. The non-transitory computer readable medium of claim 17, wherein the link-based attribute pre-process further comprises a second propagation iteration that expands the node network based on the data to include a set of second tier nodes.

19. The non-transitory computer readable medium of claim 15, wherein the detection application further provides operations comprising:
performing a basic attribute pre-process on the data to generate a set of basic attributes for the target provider; and
classifying the target provider based on a combination of the set of link-based attributes and the set of basic attributes.

20. The non-transitory computer readable medium of claim 15, wherein classifying the target provider, further comprises:
generating, by a classification heuristic, a misuse probability based on receiving the set of link-based attributes.
